(19) United States
(12) Patent Application Publication
(10) Pub. No.: US 2025/0225713 A1
(43) Pub. Date: Jul. 10, 2025

(54) ELECTRONIC DEVICE AND METHOD FOR RESTORING SCENE IMAGE OF TARGET VIEW

(71) Applicant: SAMSUNG ELECTRONICS CO., LTD., Suwon-si (KR)

(72) Inventors: Sungheon PARK, Suwon-si (KR); Minjung SON, Suwon--si (KR); Nahyup KANG, Suwon-si (KR)

(73) Assignee: SAMSUNG ELECTRONICS CO., LTD., Suwon-si (KR)

(21) Appl. No.: 18/812,660

(22) Filed: Aug. 22, 2024

(30) Foreign Application Priority Data
Jan. 5, 2024 (KR) 10-2024-0001984

(51) Int. Cl. G06T 15/20; G06T 7/90

(52) U.S. Cl. CPC G06T 15/20; G06T 7/90; G06T 2207/10024; G06T 2207/20081; G06T 2207/20084

(57) ABSTRACT

A device and method for performing scene restoration, including: obtaining an input image of an object; based on an input viewpoint corresponding to the input image, determining a plurality of augmented viewpoints surrounding the object in a three-dimensional (3D) space including the object; generating a plurality of augmented images at the plurality of augmented viewpoints, wherein each augmented image from among the plurality of augmented images corresponds to a view of the object from a corresponding augmented viewpoint from among the plurality of augmented viewpoints, and wherein each augmented image is generated based on an image at a different viewpoint using a view change model; generating a scene restoration model based on the input image at the input viewpoint and the plurality of augmented images at the plurality of augmented viewpoints; and restoring a scene image of a target view of the object using the scene restoration model.

### CROSS-REFERENCE TO RELATED APPLICATION

This application claims priority under 35 U.S.C. § 119 to Korean Patent Application No. 10-2024-0001984, filed on Jan. 5, 2024, in the Korean Intellectual Property Office, the disclosure of which is incorporated by reference herein in its entirety.

### BACKGROUND

### 1. Field

The disclosure relates to restoration of a scene image with a target view.

### 2. Description of Related Art

Computer graphics may be used to create a photorealistic synthesis of an image and a video. Methods and representations for mimicking an imaging model of a real camera may include complex materials and global illumination processing. These methods may simulate light propagation from a light source to a virtual camera for synthesis based on the laws of physics. In order to accomplish this, physical parameters of a scene may be determined in a rendering process. For example, the physical parameters may include information about scene geometry and material properties such as reflectivity or opacity. When such information is provided, some ray tracing techniques may generate photorealistic images. In addition to physics-based rendering methods, various techniques based on mathematical approximation may provide results which are similar to real imaging models.

Neural rendering may refer to converting scene parameters into an output image using a neural network. The scene parameters may include a one-dimensional (1D) input provided directly to the neural network, or may include a two-dimensional (2D) input generated using classical computer graphics pipelines. A deep neural network may be used to observe a real scene and learn a method of modeling and rendering the scene. The deep neural network may be interpreted as a general-purpose function approximator. Neural scene representation data generated based on neural rendering may be used to generate a 2D scene image.

### SUMMARY

One or more example embodiments may address at least the above problems and/or disadvantages and other disadvantages not described above. Also, the example embodiments are not required to overcome the disadvantages described above, and an example embodiment may not overcome any of the problems described above.

In accordance with an aspect of the disclosure, a scene restoration method performed by at least one processor includes: obtaining an input image of an object; based on an input viewpoint corresponding to the input image, determining a plurality of augmented viewpoints surrounding the object in a three-dimensional (3D) space including the object; generating a plurality of augmented images at the plurality of augmented viewpoints, wherein each augmented image from among the plurality of augmented images corresponds to a view of the object from a corresponding augmented viewpoint from among the plurality of augmented viewpoints, and wherein each augmented image is generated based on an image at a different viewpoint using a view change model; generating a scene restoration model based on the input image at the input viewpoint and the plurality of augmented images at the plurality of augmented viewpoints; and restoring a scene image of a target view of the object using the scene restoration model.

The determining of the plurality of augmented viewpoints may include determining positions on a surface of a virtual solid figure surrounding the object in the 3D space as the plurality of augmented viewpoints.

The generating of the each augmented image based on the image at the different viewpoint using the view change model may include: determining a plurality of reference viewpoints around the each augmented viewpoint; generating a plurality of candidate images at the each augmented viewpoint based on a plurality of reference images at the plurality of reference viewpoints using the view change model; and selecting an augmented image at the each augmented viewpoint from among the plurality of candidate images.

The selecting of the augmented image may include: obtaining a retransformed image by transforming each candidate image from among the plurality of candidate images to a corresponding reference viewpoint using the view change model; and selecting the augmented image based on a comparison between the retransformed image and a corresponding reference image.

The selecting of the augmented image may include: calculating a learned perceptual image patch similarity (LPIPS) loss between the retransformed image and the corresponding reference image; and selecting a candidate image having a smallest LPIPS loss from among the plurality of candidate images as the augmented image.

The generating of the augmented image based on the image at the different viewpoint using the view change model may include generating an augmented image at each augmented viewpoint sequentially in an order of increasing distance from the input viewpoint.

The view change model may include a diffusion model, and the generating of the plurality of augmented images may include: providing parameters based on a rotation parameter and a translation parameter for transformation of a reference viewpoint into an augmented viewpoint to the diffusion model together with a reference image at the reference viewpoint to generate a candidate image at the augmented viewpoint; and providing a parameter for transformation of the augmented viewpoint into the reference viewpoint to the diffusion model together with the candidate image at the augmented viewpoint to generate a retransformed image.

The restoring of the scene image may include: generating scene information including color information and volume density information based on the scene restoration model; and restoring the scene image by repeatedly determining a pixel value for each pixel from among a plurality of pixels in a view to be restored by performing volume rendering on the scene information.

The scene restoration model may include: a deformation estimation model configured to convert coordinates of a point in the 3D space into coordinates corresponding to a canonical frame with reference to deformation code; and a neural scene representation (NSR) estimation model configured to estimate color information and volume density information based on the converted coordinates according to the canonical frame.

The generating of the scene restoration model may include: generating a temporary image by providing, to the scene restoration model, a deformation code and coordinates for each point from among a plurality of points in the 3D space corresponding to a ray for each pixel in a two-dimensional (2D) scene corresponding to a view to be restored; updating parameters of the scene restoration model and the deformation code based on a loss between the generated temporary image and a training image corresponding to the 2D scene; and based on the updating of the parameters of the scene restoration model and the deformation code converging, mapping the converged deformation code to a frame identifier indicating the training image.

In accordance with an aspect of the disclosure, a rendering device includes: a memory configured to store a view change model and a scene restoration model; and at least one processor configured to: obtain an input image of an object, based on an input viewpoint corresponding to the input image, determine a plurality of augmented viewpoints surrounding the object in a three-dimensional (3D) space including the object, generate a plurality of augmented images at the plurality of augmented viewpoints, wherein each augmented image from among the plurality of augmented images corresponds to a view of the object from a corresponding augmented viewpoint from among the plurality of augmented viewpoints, and wherein each augmented image is generated based on an image at a different viewpoint using the view change model, generate the scene restoration model based on the input image at the input viewpoint and the plurality of augmented images at the plurality of augmented viewpoints, and restore a scene image corresponding to a target view of the object using the scene restoration model.

The at least one processor may be further configured to determine positions on a surface of a virtual solid figure surrounding the object in the 3D space as the plurality of augmented viewpoints.

The at least one processor is configured to: determine a plurality of reference viewpoints around the each augmented viewpoint; generate a plurality of candidate images at the each augmented viewpoint based on a plurality of reference images at the plurality of determined reference viewpoints using the view change model; and select an augmented image at the each augmented viewpoint from among the plurality of candidate images.

The at least one processor may be further configured to: obtain a retransformed image by transforming each candidate image from among the plurality of candidate images to a corresponding reference viewpoint using the view change model; and select the augmented image based on a comparison between the retransformed image and a corresponding reference image.

The at least one processor may be further configured to: calculate a learned perceptual image patch similarity (LPIPS) loss individually between the retransformed image and the corresponding reference image; and select a candidate image having a smallest LPIPS loss from among the plurality of candidate images as the augmented image.

The at least one processor may be further configured to generate an augmented image at each augmented viewpoint sequentially in an order of increasing distance from the input viewpoint.

The view change model may include a diffusion model, and the at least one processor may be further configured to: provide parameters based on a rotation parameter and a translation parameter for transformation of a reference viewpoint into an augmented viewpoint to the diffusion model together with a reference image at the reference viewpoint to generate a candidate image at the augmented viewpoint; and provide a parameter for transformation of the augmented viewpoint into the reference viewpoint to the diffusion model together with the candidate image at the augmented viewpoint to generate a retransformed image.

The at least one processor may be further configured to: generate scene information including color information and volume density information based on the scene restoration model; and restore the scene image by repeatedly determining the pixel value for each pixel from among a plurality of pixels in a view to be restored by performing volume rendering on the scene information.

The scene restoration model may include: a deformation estimation model configured to convert coordinates of a point in the 3D space into coordinates corresponding to a canonical frame with reference to deformation code; and a neural scene representation (NSR) estimation model configured to estimate color information and volume density information based on the converted coordinates according to the canonical frame.

The at least one processor may be further configured to: generate a temporary image by providing, to the scene restoration model, a deformation code and coordinates for each point from among a plurality of points in the 3D space corresponding to a ray for each pixel in a two-dimensional (2D) scene corresponding to a view to be restored; update parameters of the scene restoration model and the deformation code based on a loss between the generated temporary image and a training image corresponding to the 2D scene; and based on the updating of the parameters of the scene restoration model and the deformation code converging, map the converged deformation code to a frame identifier indicating the training image.

In accordance with an aspect of the disclosure, a scene restoration method performed by a at least one processor includes obtaining an input image of an input view at an input viewpoint, wherein the input image may include an object; determining a plurality of augmented viewpoints around the object in a three-dimensional (3D) space including the object; generating a plurality of augmented images at the plurality of augmented viewpoints by applying a view change model to at least one reference image at a reference viewpoint different from the plurality of augmented viewpoints; generating a scene restoration model based on the input image and the plurality of augmented images; and restoring a scene image of the object at a target viewpoint different from the input viewpoint using the scene restoration model.

The generating of the plurality of augmented images may include: determining a plurality of reference viewpoints corresponding to the plurality of augmented viewpoints; generating a plurality of candidate images corresponding to each augmented viewpoint from among the plurality of augmented viewpoints by providing the plurality of reference images to the view change model; generating a plurality of retransformed images by providing the plurality of candidate images to the view change model; and selecting the plurality of augmented images from among the plurality of candidate images based on a comparison between the plurality of candidate images and the plurality of reference images.

The scene restoration model may include: a deformation estimation model configured to convert coordinates of a point in the 3D space into coordinates corresponding to an input frame corresponding to the input image with reference to a deformation code; and a neural scene representation (NSR) estimation model configured to estimate color information and volume density information based on the converted coordinates according to the input frame, and the generating of the scene restoration model may include: generating a temporary image by providing, to the scene restoration model, the deformation code and the coordinates for a plurality of points in the 3D space along a ray for each pixel in an augmented image from among the plurality of augmented images; updating parameters of the scene restoration model and the deformation code based on a loss between the generated temporary image and the augmented image until convergence of the deformation code occurs; and mapping the converged deformation code to a frame identifier indicating the augmented image.

Additional aspects of example embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain example embodiments with reference to the accompanying drawings, in which:

FIG. 1 illustrates an example of a neural scene representation according to an embodiment;

FIG. 2 is a flowchart illustrating a method of generating a scene restoration model according to an embodiment;

FIG. 3 illustrates setting of a viewpoint relative to an object according to an embodiment;

FIG. 4 illustrates a diffusion model according to an embodiment;

FIG. 5 illustrates generation of an augmented image for each viewpoint according to an embodiment;

FIG. 6 illustrates a scene restoration model according to an embodiment;

FIG. 7 illustrates generation of a scene image representing an object that has changed over time using a scene restoration model according to an embodiment;

FIG. 8 is a block diagram illustrating an example of a configuration of a rendering device according to an embodiment; and

FIG. 9 is a block diagram illustrating an example of a configuration of an electronic device according to an embodiment.

### DETAILED DESCRIPTION

The following detailed structural or functional description is provided as an example only, and various alterations and modifications may be made to the described embodiments. Accordingly, embodiments of the disclosure should not be construed as limited to the particular embodiments described below, and should be understood to include all changes, equivalents, and replacements within the idea and the technical scope of the disclosure.

Although terms such as first, second, and the like are used to describe various components, the components are not limited to these terms. These terms are intended only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, or the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, some embodiments are described in detail with reference to the accompanying drawings. In the following description, like reference numerals refer to like elements, and redundant or duplicative description related thereto may be omitted.

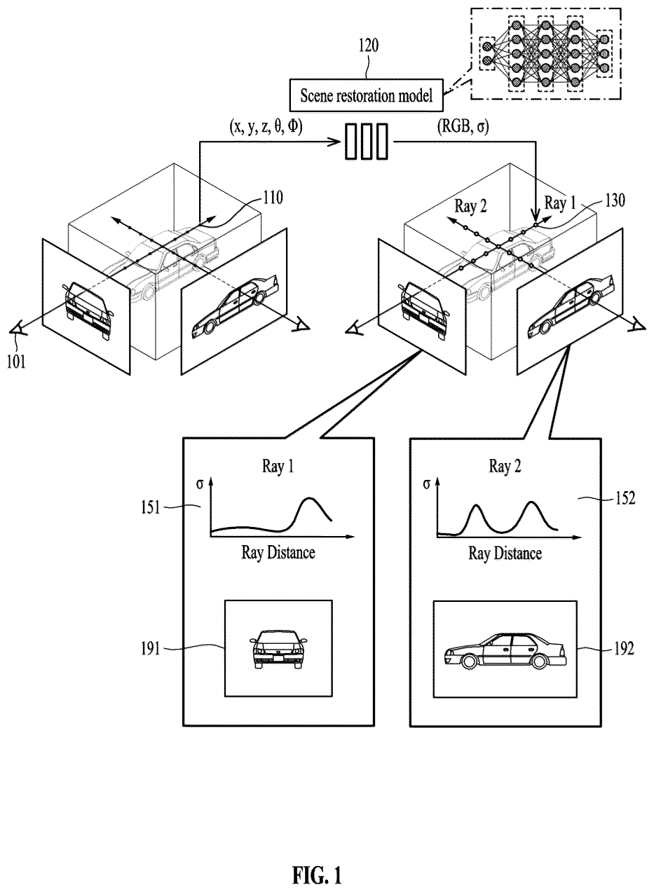

FIG. 1 illustrates an example of a neural scene representation according to an embodiment.

According to an embodiment, a scene of a three-dimensional (3D) space may be represented based on neural scene representation (NSR) for each point in the 3D space. The NSR may represent understanding and representing a scene (e.g., a visual scene) using a neural network. For example, a component of a scene may be divided and/or reconstructed into components for NSR.

A scene corresponding to a predetermined view may be a scene in which a 3D space is viewed at a viewpoint 101 and in a view direction corresponding to the predetermined view. Each pixel included in an image representing a scene (e.g., a scene image) may have a pixel value determined based on component values (e.g., a color value and a density value) of points in a 3D space, through which rays may pass from the viewpoint 101 toward corresponding pixels. Color information and density information will be described below. Accordingly, the scene image may be represented based on scene component values of points according to a plurality of rays (e.g., a ray bundle) respectively corresponding to pixels in the 3D space.

Information including a predetermined point in the 3D space and scene component values corresponding to a view (e.g., a ray from the viewpoint 101 toward the corresponding point), from which the corresponding point is viewed, may be referred to as scene information 130. The scene information 130 may be generated using a neural network-based model, examples of which are described below (e.g., a scene restoration model 120). The scene information 130 may be NSR data including a predetermined point and color information and density information according to a ray corresponding to the corresponding point.

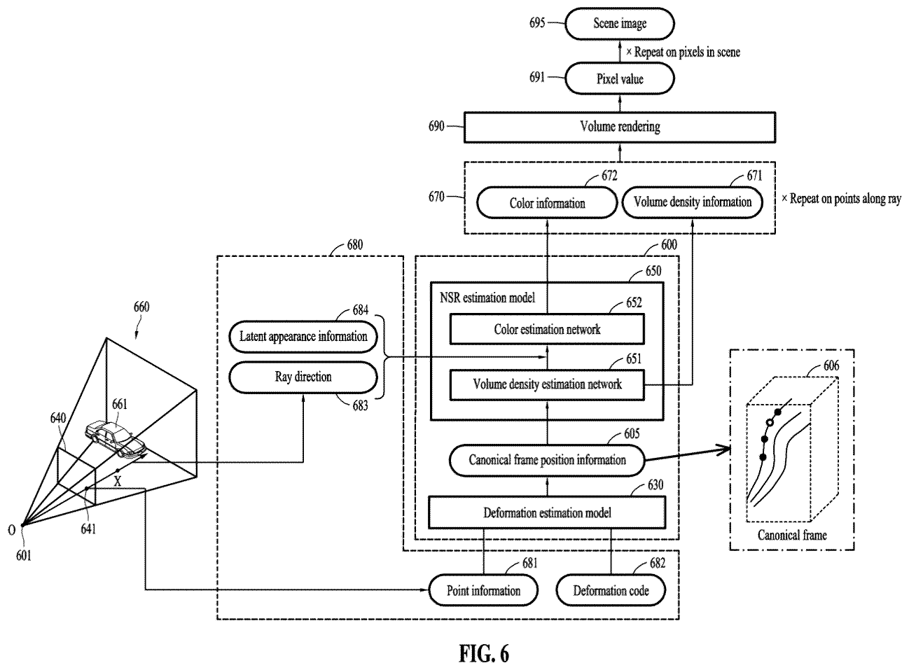

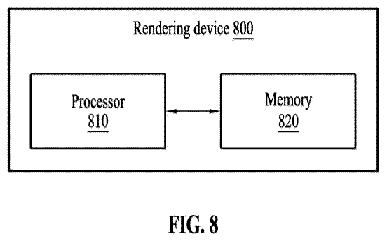

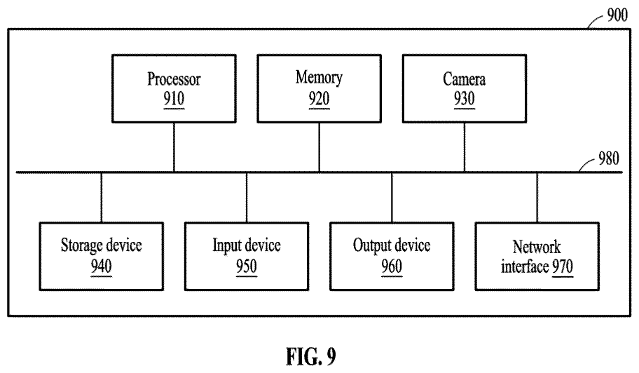

FIG. 1 shows an example in which, based on a query input 110 specifying a point in the 3D space, the scene information 130 corresponding to the corresponding point may be derived. For example, a rendering device (e.g., a rendering device 800 of FIG. 8 or an electronic device 900 of FIG. 9) may generate the scene information 130 of a corresponding point based on the scene restoration model 120 (e.g., an NSR model) based on the query input 110 for each point in the 3D space. The scene restoration model 120 may be a module designed and trained to output the scene information 130 from the query input 110, and may include, for example, a neural network. An example of the scene restoration model 120 is described below with reference to FIG. 6.

The query input 110 for each point may include coordinates representing a corresponding point in the 3D space and a direction of a ray (e.g., a ray direction). The ray direction may be a direction of a ray (e.g., Ray 1 or Ray 2 of FIG. 1) passing through a pixel and/or points corresponding to the pixel from a viewpoint from which a two-dimensional (2D) scene to be synthesized and/or restored is viewed. FIG. 1 illustrates coordinates (x, y, z) and direction information (θ, ϕ) as an example of the query input 110. The coordinates (x, y, z) may be coordinates according to the Cartesian coordinate system based on a predetermined origin point, and (θ, ϕ) may be angles formed between the ray direction and two predetermined reference axes (e.g., a positive direction of a z-axis and a positive direction of an x-axis).

The scene information 130 may be data representing component values for representing a scene viewed in various view directions in a 3D space. The scene information 130, as NSR data, may include, for example, neural radiance field (NeRF) data. Herein, a model that is designed and trained to output NeRF data based on a predetermined input (e.g., the query input 110) may be referred to as a NeRF model. The scene information 130 may include color information and volume density (e.g., volume density 151 and volume density 152) of the 3D space for each point and for each ray direction. The color information may include color values according to a color space (e.g., a red value, a green value, and a blue value according to an RGB color space). The volume densities 151 and 152, denoted as σ, of a predetermined point may be interpreted as a possibility (e.g., differential probability) that a ray ends at an infinitesimal particle of the corresponding point. In the graphs of the volume densities 151 and 152 shown in FIG. 1, the horizontal axis may denote a distance from a view point along a ray corresponding to a pixel, and the vertical axis may denote the value of the volume density according to the distance. A color value (e.g., RGB value) may also be determined according to the distance along the ray. In addition, even at the same point, the volume densities 151 and 152 and color values may vary depending on the ray direction. Depending on the viewpoint, when the same point is observed in different directions, the volume densities 151 and 152 and the color may vary. However, the scene information 130 is not limited to the above description, and may vary according to the design.

In embodiments, storing the scene information 130 as described above may correspond to training the scene restoration model 120 (e.g., the neural network) using 3D scene information, and loading the scene information 130 may correspond to outputting the information 130 by inputting the query input 110 to the scene restoration model 120.

The neural network for generating the scene information 130 may have a multi-layer perceptron (MLP) structure. The neural network may be trained to generate an output (e.g., RGB value, volume densities 151 and 152) for a sample point with respect to an input value (e.g., (x, y, z, θ, ϕ) of the corresponding sample point). For example, a ray direction may be defined for each pixel of 2D scene image 191 and scene image 192, and output values (e.g., NSR data) of all sample points on the ray direction may be calculated through a neural network operation. In FIG. 1, the 2D scene image 191 of a vehicle object viewed from the front and the 2D scene image 192 of the vehicle object viewed from the side are shown. According to embodiments, the query input 110 may vary depending on the design. FIG. 1 shows only point information (e.g., (x, y, z) as coordinate values of a point) and the ray direction (e.g., direction information of (θ, ϕ)) for clarification, however, referring to FIG. 6, deformation code and latent appearance information may also be provided to the scene restoration model.

The MLP-based neural network (which may be referred to as an MLP network) shown as an example of the scene restoration model 120 in FIG. 1 may include an input layer, a hidden layer, and an output layer. Each of the input layer, the hidden layer, and the output layer includes a plurality of artificial nodes. Although FIG. 1 illustrates an example including three hidden layers for ease of description, embodiments are not limited thereto, and in some embodiments, various numbers of hidden layers may be included. In addition, although the neural network (e.g., the MLP network) is illustrated in FIG. 1 as including a separate input layer to receive input data, the input data may be input directly into a hidden layer. In the neural network, artificial nodes of layers other than the output layer may be connected to artificial nodes of a next layer through links for transmitting output signals. The number of links may correspond to the number of artificial nodes included in the next layer. An output of an activation function related to weighted inputs of the artificial nodes included in a previous layer may be input to each artificial node included in the hidden layer. The weighted inputs may be obtained by multiplying a weight by inputs of the artificial nodes included in the previous layer. The weight may be referred to as a parameter of the neural network. The activation function may include sigmoid, hyperbolic tangent (tanh) and rectified linear unit (ReLU), and the nonlinearity may be formed in the neural network by the activation function. Weighted inputs of artificial nodes included in a previous layer may be input to each artificial node included in the output layer. Although FIG. 1 illustrates the scene restoration model 120 as including one MLP network, embodiments are not limited thereto. As described below with reference to FIG. 6, the scene restoration model 120 may include three neural networks (e.g., MLP networks).

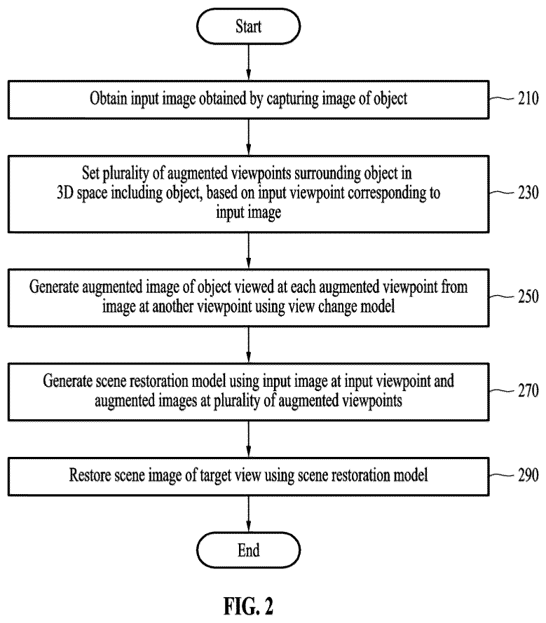

FIG. 2 is a flowchart illustrating a method of generating a scene restoration model according to an embodiment.

At operation 210, a rendering device (e.g., a rendering device of FIG. 8) may obtain an input image obtained by capturing an image of an object. For example, the rendering device may capture an input image using a vision sensor (e.g., a camera sensor). As another example, the rendering device may receive an input image captured by an external device (e.g., a camera device) using a communication module (e.g., a communication circuit). An object may be, for example, at least one of a person, thing, animal, and plant.

At operation 230, the rendering device may set, select, or otherwise determine a plurality of augmented viewpoints surrounding the object in a 3D space including the object, based on an input viewpoint corresponding to the input image. According to embodiments, a view may refer to a perspective for observing and/or capturing a scene and/or an object in a scene.

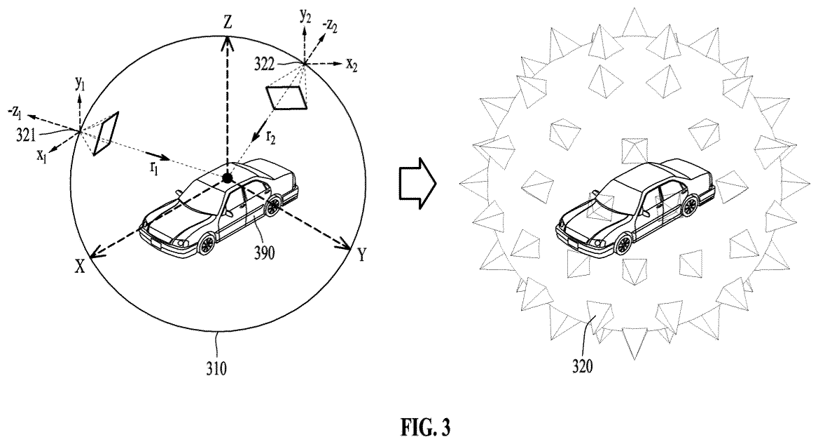

According to an embodiment, the view may be represented by a viewpoint and a view direction. The viewpoint may be positioned on a surface of a virtual solid figure that is set relative to the object. The view direction may be a direction in which an object is viewed from a viewpoint, and may be, for example, a direction toward a predetermined point (e.g., a center point as a reference point) of the object. However, the view direction is not limited thereto, and may be a direction passing through a center point of a field of view (FOV) from a viewpoint when the FOV of a camera includes an object. As another example, the view direction may be a direction passing through a principal point of a camera from a viewpoint of the camera. According to embodiments, the camera may be a camera device implemented as a physical device, or the camera may be a kind of virtual camera that may have predetermined camera parameters. A view from which an input image is captured, may be referred to as an input view, and a viewpoint corresponding to the input view may be referred to as an input viewpoint. A plurality of augmented viewpoints may also be positioned on a surface (or interface) of a solid figure surrounding the object described above. An example of setting the viewpoint is described below with reference to FIG. 3. In the example shown in FIG. 3 below, each of a plurality of views may have its own viewpoint and view direction.

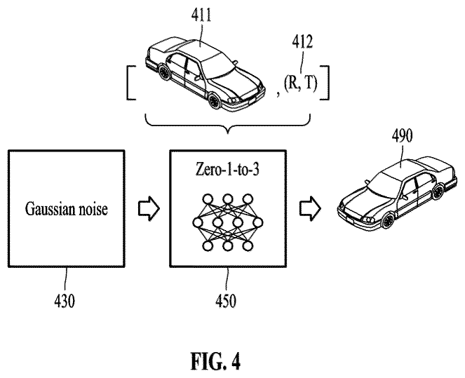

At operation 250, the rendering device may generate an augmented image of the object viewed at each augmented viewpoint from an image at another viewpoint (e.g., a different viewpoint) using a view change model. An augmented view may be a new view that is different from an original view (e.g., an input view). An augmented viewpoint may be a viewpoint that is different from an original viewpoint (e.g., a viewpoint of an input view in which an input image is captured or is assumed to be captured). A view change model may be a machine learning model that is designed and trained to convert an image of a predetermined view into an image of another view, and may be, for example, a diffusion model. An example of a diffusion model is described below with reference to FIG. 4. The rendering device may refer to an image at another viewpoint around a corresponding augmented viewpoint in order to generate an augmented image at each augmented viewpoint.

At operation 270, the rendering device may generate a scene restoration model using the input image at the input viewpoint and the augmented images at the plurality of augmented viewpoints. The scene restoration model may be a model that is designed and trained to output information (e.g., scene information) used to restore a scene from a given view in which an object positioned in a 3D space is viewed from the given view (e.g., a viewpoint and a view direction). The input image at the input viewpoint and the augmented images at the augmented viewpoints may be used as training data (e.g., ground truth (GT) data) for the scene restoration model. A training input of the training data may be an input that indicates a view (e.g., a viewpoint and a view direction), and a training output may be a corresponding image (e.g., an image showing a scene observed according to a corresponding view). However, the configuration of the training data is not limited thereto. An example of the training of the scene restoration model is described below with reference to FIG. 6.

At operation 290, the rendering device may restore a scene image of a target view using the scene restoration model. The target view may be a view that is to be restored. A viewpoint and a view direction of the target view may be input by a user, however, embodiments are not limited thereto, and the rendering device may automatically determine a view corresponding to a scene that is intended to be visualized in an application (e.g., a game application). The rendering device may determine a ray from the viewpoint of the target view toward a corresponding pixel for each pixel corresponding to a 2D scene corresponding to the target view. The rendering device may sample points (e.g., sample points) in a 3D space including the object along the determined ray. The rendering device may provide a ray direction and point information (e.g., a coordinate value) that indicates the sampled point to the scene restoration model to generate scene information (e.g., color information and density information) of the sampled point. The rendering device may perform volume rendering on points along the ray corresponding to the pixel using the generated pieces of scene information. The rendering device may determine a pixel value of the pixel as a result of the volume rendering. The rendering device may restore the scene image by repeatedly determining pixel values based on the scene restoration model and the volume rendering described above for all pixels belonging to a scene to be restored.

According to an embodiment, the rendering device may restore a 3D structure from a single input image. The rendering device may automatically generate a detailed representation of a 3D object from a 2D image using a generative model. The rendering device may perform photorealistic rendering and restoration of an accurate 3D image. For example, a scene restoration method may be widely used for providing a virtual reality (VR) image, providing an augmented reality (AR) image, providing a 3D game image, generating visual special effects, encoding an image, autonomous driving, object recognition, and the like. For example, an image generated by the scene restoration method may be used as 3D training data for various tasks (e.g., autonomous driving and object recognition).

For example, the rendering device may obtain a single input image at operation 210, and may generate augmented images at a plurality of viewpoints based on this single input image. The augmented images may be used in the training of the scene restoration model (e.g., the NeRF models) as described above. As a result, according to an embodiment, the scene restoration model may be trained using consistent images from the single input image.

Although operations 210, 230, 250, and 290 are described herein as being performed by the rendering device for ease of description, embodiments are not limited thereto. For example, the generation operation according to operations 210, 230, and 250 may be performed by the rendering device, and the restoration operation according to operation 290 may be performed by another rendering device. In addition, operations 210, 230, 250, and 290 may be distributed to a plurality of devices and may be performed cooperatively.

FIG. 3 illustrates an example of setting a viewpoint relative to an object according to an embodiment.

A rendering device according to an embodiment may set a plurality of augmented viewpoints 322 for an object 390. As described above, the rendering device may determine an input view from an input image including the object 390. The input view may include an input viewpoint 321 and an input view direction. The input viewpoint 321 may represent a point at which a camera (e.g., a virtual camera) that captures the input image is located. When the Cartesian coordinate system (e.g., an XYZ coordinate system) based on the object 390 is set, position coordinates of the input viewpoint 321 may be represented based on the XYZ coordinate system. The input view direction is a direction in which the object 390 is viewed from the input viewpoint 321, and FIG. 3 shows the input view direction as a first view direction r₁ that passes through a center point of a FOV or a principal point of a first virtual camera.

Although FIG. 3 shows the first view direction r₁ as a direction in which the object 390 is viewed at a tilted angle, however, embodiments are not limited thereto. As described below, a positional relationship between a vision sensor and the object 390 may not be given. The vision sensor may be a sensor that senses or is configured to sense visual information, and may include, for example, a camera sensor. In this case, a first camera coordinate system (e.g., an x₁y₁z₁ coordinate system) of a first camera that has captured the input image may be arbitrarily matched to a reference coordinate system (e.g., the XYZ coordinate system) set based on the object 390. For example, the object 390 shown in the input image may be captured in front view. Accordingly, the first view direction r₁ may correspond to a-X-axis direction. Thus, the XYZ coordinate system based on the object 390 may be set such that an X-axis direction and the first view direction r₁ are opposite to each other. However, embodiments are not limited thereto, and the camera coordinate system and the object-based coordinate system may be matched in various ways. An origin point of the XYZ coordinate system may be set to a reference point (e.g., a center point) of the object 390. The XYZ coordinate system based on the object 390 may be a coordinate system of a 3D virtual space where the object 390 is located.

The rendering device may determine the input viewpoint 321 and the plurality of augmented viewpoints 322 in the 3D virtual space based on the input image and the object 390. The rendering device may determine augmented views having a view direction r₂ from viewpoints 320 surrounding the object 390 individually toward the object 390 around the object 390 in the 3D virtual space. For example, the rendering device may determine positions along a surface of a virtual solid FIG. 310 surrounding the object 390 in the 3D space as the plurality of augmented viewpoints 322. A shape of the solid FIG. 310 may be, for example, a sphere or hemisphere. The rendering device may determine the solid FIG. 310 based on a distance from the input view to the object 390. For example, the rendering device may determine a radius of a sphere or hemisphere as a distance from the input viewpoint 321 to the object 390. However, embodiments are not limited thereto, and a solid FIG. 310 having various shapes on which the viewpoints are disposed may be used, and a size of the solid FIG. 310 may be determined such that the entire shape of the object 390 is included in an image a single view.

Parameters of the vision sensor may include, for example, a focal length and a principal point as intrinsic parameters of the camera. A positional relationship between the object 390 and the vision sensor may, for example, include a distance from the vision sensor to the object 390. According to embodiments, when information about the vision sensor and the object 390 is not given, default information may be used for the parameters of the vision sensor and the positional relationship between the object 390 and the vision sensor. A camera corresponding to the default information may be referred to as a default camera. As described above, an input image may be captured by a virtual camera which may correspond to a default camera. Parameters of the default camera (e.g., intrinsic parameters of the camera) and a distance between the default camera and the object 390 may be given in advance or input by a user. A focal length and a principal point of the vision sensor may be set (or assumed) as a default focal length and a default principal point. For example, a default FOV may be 60° and a default image size may be 256×256. The unit of the default image size may be the number of pixels. The default focal length may be calculated according to Equation 1 below:

$$Focal length = ( number of pixels on an axis of an image / 2 ) / tan ( FOV / 2 ) \qquad ( Equation 1 )$$

In Equation 1 above, the focal length may be expressed as a distance in pixels. The distance to the vision sensor and the object 390 may also be set as a default distance (e.g., 1 m). In addition, various parameters of the camera not mentioned and pieces of information to be considered for the determination of the solid FIG. 310 including the object 390 in the 3D space may be set as default values in advance.

The rendering device may place the plurality of viewpoints 320 (e.g., augmented viewpoints 322) in a 3D space as described above such the object 390 may be covered or viewed from various angles (e.g., various perspectives). For example, the rendering device may place 100 to 150 viewpoints 320 in a 3D virtual space.

According to embodiments, the size of the object 390 in the 3D virtual space may be a relative size determined by a geometric relationship between the camera and the object 390, rather than the actual physical size. When the object 390 is integrated into another space (e.g., a 3D space based on a different coordinate system), the rendering device may adjust the size of the object 390 to be provided in the other space, for example, by applying a scale factor to the size of the object 390.

FIG. 4 illustrates a diffusion model according to an embodiment.

A rendering device (e.g., the rendering device 800 of FIG. 8) may generate augmented images corresponding to a plurality of views. An augmented image corresponding to an augmented view that corresponds to an augmented viewpoint may be an image in which an object is observed or viewed at the corresponding augmented viewpoint. In embodiments, the augmented image may be referred to as an augmented image of the augmented view, and may also be described as an augmented image at the augmented viewpoint.

The rendering device may translate or transform an object of an input image 411 into an object of an image of a view that is different from the input view based on a view change model. A view change model may be a model that is designed and trained to generate an output image 490 that represents the object of the input image 411 according to a changed view. The view change model may be based on a diffusion model (e.g., a diffusion probabilistic model or a score-based generative model). A view change model may also be referred to as a viewpoint change model.

A diffusion model 450 may be a neural network model that generates a restored image using diffusion of a noise 430. The diffusion model 450 may be an image generative model that generates a restored image having a desired probability distribution from the noise 430 through repeated operations of a neural network. The rendering device may perform a diffusion process and a reverse diffusion process using the diffusion model 450.

The diffusion process may be a process of gradually adding values of the noise 430 along a fixed normal distribution (e.g., Gaussian distribution) to pixel values of an image (or a feature map). For example, the rendering device may input a low-resolution image and the noise 430 having a normal distribution to the diffusion model 450. The rendering device may gradually add the noise 430 to a low-resolution input image in several steps by propagating the low-resolution input image (or features of an input image) in the diffusion model 450 according to the diffusion process. A feature may refer to feature data in which an image is abstracted, and may be in the form of a feature map. In the diffusion process, the noise 430 generated by a fixed normal distribution may be gradually added to the input image.

The reverse diffusion process may be a process that is performed in a reverse direction of the diffusion process. The reverse diffusion process may be a process of gradually subtracting (or removing) the values of the noise 430 generated in the trained normal distribution from the pixel values of the image (or the feature map) using the trained diffusion model 450. For example, the noise 430 may be in a normal distribution form, such as Gaussian noise, but embodiments are not limited thereto. For example, the rendering device may gradually remove the noise 430 from the image in several steps by propagating the image including the noise 430 (or features to which the noise 430 is added) in the diffusion model 450 according to the reverse diffusion process. The rendering device may generate a result image having a probability distribution similar to a probability of an input image through the reverse diffusion process. The reverse diffusion process may be a process for generating a sample using a generative model, and may also be referred to as a “sampling” process. The reverse diffusion process may be performed, for example, using a denoising diffusion probabilistic model (DDPM) or denoising diffusion implicit model (DDIM).

According to embodiments, the diffusion model 450 may correspond to a deep generative model that is designed and trained to restore data by adding the noise 430 to available training data in the diffusion process and then removing the noise 430 by performing the reverse diffusion process on the available training data. The diffusion model 450 may be gradually trained with a method of removing the noise 430, and a trained process for removing the noise 430, for example the reverse diffusion process, may generate a new result image with high quality from a predetermined image of the noise 430. The diffusion model 450 may use the diffusion process to generate a result image having a probability distribution which is similar to the probability distribution of the input image. In the reverse diffusion process, the training may be performed while updating an average and standard deviation, which may be probability distribution parameters for the generation of the noise 430.

In some embodiments, a Zero-shot One Image to 3D Object (Zero-1-to-3) model may be included in the diffusion model 450. The Zero-1-to-3 model may be a model that is designed and trained to generate an image of another view that is rotated from an input image. The Zero-1-to-3 model may be a conditioned diffusion model that is trained according to a change of an image according to view rotation based on an object using a ground truth 3D scene. The rendering device may provide a function of image-to-3D generation by using the Zero-1-to-3 model as the diffusion model 450 described above.

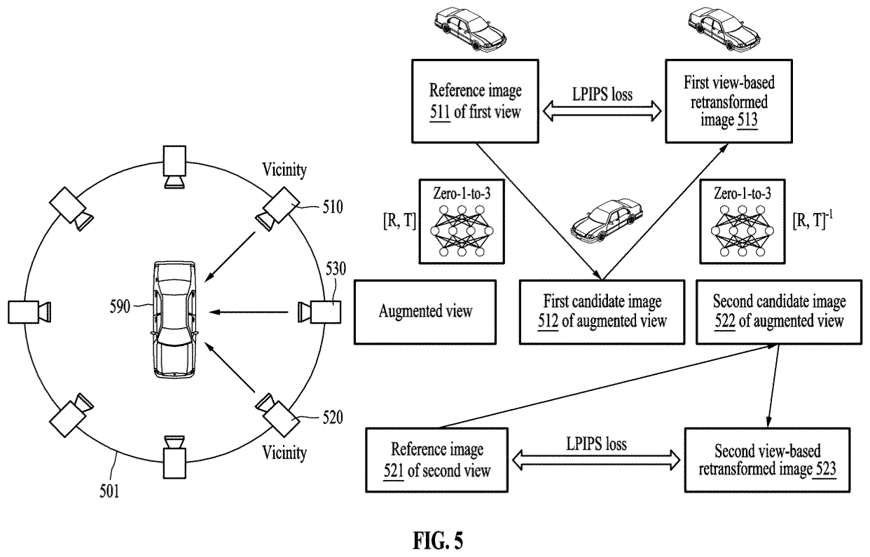

The rendering device may generate the output image 490 showing a portion (e.g., an object) of the input image 411 rotated according to rotation information 412, based on the input image and the rotation information 412, using the diffusion model 450 (e.g., the Zero-1-to-3 model). The rotation information 412 may be an extrinsic parameter of a camera for converting a camera coordinate system of a camera located on a predetermined view into a camera coordinate system of a camera located on a target view, and may include a rotation parameter and a translation parameter. The rotation parameter may be a matrix R that rotationally converts coordinates based on one coordinate system into coordinates based on another coordinate system. The translation parameter may be a matrix T that translates coordinates based on one coordinate system to coordinates based on another coordinate system. An example of a method of improving 3D consistency between generated images using the diffusion model 450 is described below with reference to FIG. 5.

FIG. 5 illustrates generation of an augmented image for each viewpoint according to an embodiment.

A rendering device may generate augmented images individually for a plurality of augmented views. For example, the rendering device may generate an augmented image at a viewpoint that is close to a viewpoint (e.g., an input viewpoint) corresponding to an input image. The augmented image may be an image that represents an object 590 which is the same as or similar to the input image, while representing the object 590 according to view other than a view (e.g., an input view) corresponding to the input image. FIG. 5 shows a top view of the object 590 and views facing the object 590 in a 3D space.

According to an embodiment, the rendering device may determine a plurality of reference viewpoints for a corresponding viewpoint in the vicinity of each viewpoint of the plurality of augmented viewpoints. For example, the rendering device may select a first view 510 and a second view 520 in the vicinity of an augmented view 530 (e.g., relatively close to the augmented view 530 in comparison with other views). The first view 510 may be a view in which the object 590 is viewed at a first viewpoint in a first view direction, and the second view 520 may be a view in which the object 590 is viewed at a second viewpoint in a second view direction. The rendering device may have or obtain a first reference image corresponding to the first view 510 and a second reference image corresponding to the second view 520. The first view 510 and the second view 520 may be positioned on a solid FIG. 501 surrounding the object 590 in the 3D space, and may be the basis for the translation (or transformation) to the augmented view.

The rendering device may generate a plurality of candidate images at a corresponding viewpoint based on a plurality of reference images at a plurality of determined reference viewpoints using the view change model. The view change model may be a diffusion model and may be, for example, the Zero-1-to-3 model shown in FIG. 4. The rendering device may generate a candidate image at an augmented viewpoint by providing a parameter based on a rotation parameter and a translation parameter for transforming a reference viewpoint into an augmented viewpoint to the diffusion model together with a reference image at the reference viewpoint. For example, the rendering device may generate a first candidate image 512 of an augmented view by inputting a first reference image 511 of the first view 510 and rotation information into the diffusion model (e.g., the Zero-1-to-3 model). The rotation information may include, for example, a 3×3 matrix R (e.g., the rotation parameter) that rotates and converts coordinates of the first view 510 based on the camera coordinate system into coordinates of the augmented view 530 based on the camera coordinate system, and a 3×1 matrix T (e.g., the translation parameter) for translating the coordinates of the first view 510 based on the camera coordinate system into the coordinates of the augmented view 530 based on the camera coordinate system. The rotation information may also be represented as a 3×4 matrix [R|T]. The first candidate image 512, which may be a candidate image generated based on the first reference image 511, may be an image in which the object 590 is viewed according to the augmented view 530. The rendering device may also generate a second candidate image 522 of a similarly augmented view for a second reference image 521 according to the second view 520.

The rendering device according to an embodiment may select an augmented image at a corresponding viewpoint from among the plurality of candidate images. The rendering device may individually calculate a measure of consistency that is preserved in the view conversion process for the plurality of candidate images. The rendering device may select the augmented image from among the plurality of candidate images based on the calculated measure.

For example, the rendering device may obtain a retransformed image by transforming each of the plurality of candidate images according to a reference viewpoint using the view change model. The rendering device may generate the retransformed image by providing a parameter for transforming the augmented viewpoint into the reference viewpoint to the diffusion model together with the candidate image at the augmented viewpoint. The rendering device may generate a first view-based retransformed image 513 by inputting the first candidate image 512 and the rotation information for retransformation into the diffusion model. The rotation information for retransformation may include, for example, a 3×3 matrix R^{T} that rotates and converts coordinates of the augmented view 530 in the camera coordinate system into coordinates of the first view 510 based on the camera coordinate system, and a 3×1 matrix-T (e.g., the translation parameter) for translating the coordinates of the augmented view 530 in the camera coordinate system into the coordinates of the first view 510 based on the camera coordinate system. The rotation matrix R^{T} may be a transpose matrix of the rotation matrix R described above, and the translation matrix-T may be a negative matrix of the translation matrix T described above. The rotation information for transforming the augmented view 530 into the first view 510 may also be represented as a 3×4 matrix of [R^{T}|−T]. The rendering device may also generate a second view-based retransformed image 523 similarly for the second candidate image 522 of the second view 520.

The rendering device may select an augmented image from among the plurality of candidate images based on a comparison between the retransformed image and a corresponding reference image. The rendering device may calculate the measure of consistency described above based on the comparison between the retransformed image and the corresponding reference image. A loss (e.g., an error or a difference) between the retransformed image of an original view (e.g., the first view 510 or the second view 520) and the reference image of the original view may be the measure of consistency preserved during the view transformation process. As the measure of consistency, for example, a learned perceptual image patch similarity (LPIPS) loss may be used.

The LPIPS loss may be an indicator used to evaluate a similarity between two images, and may be calculated as a similarity between two feature maps in an intermediate layer extracted by inputting each of the two images to be compared into a visual geometry group (VGG) network. For example, the rendering device may calculate the LPIPS losses individually between the retransformed images of the plurality of candidate images and the reference images of the plurality of reference images. The rendering device may select a candidate image with a smallest LPIPS loss from among the calculated LPIPS losses as an augmented image for a corresponding viewpoint. For example, the rendering device may calculate a first LPIPS loss between the first reference image 511 and the first view-based retransformed image 513, and a second LPIPS loss between the second reference image 521 and the second view-based retransformed image 523. The rendering device may determine the augmented image for the augmented view 530 as the candidate image corresponding to a loss with a smallest value of the first LPIPS loss and the second LPIPS loss. This may be because, when the loss between the retransformed image and the reference image of the original view is small, it may indicate that consistency between the augmented image for another view and the reference image is well preserved.

When n reference views are selected around the augmented view, the rendering device may generate n candidate images. The rendering device may determine the augmented image of the augmented view as the candidate image having the smallest value of the LPIPS loss described above among the n candidate images. Thus, consistency may be maintained between the augmented image and the input image.

The rendering device according to an embodiment may generate an augmented image at each augmented viewpoint sequentially in order of increasing distance from the input viewpoint (e.g., in an order from a viewpoint adjacent to an input viewpoint to a viewpoint further away from the input viewpoint from among a plurality of augmented viewpoints). For example, the rendering device may generate the augmented image for the augmented views by repeating the operation described above in the order from the view adjacent to the input view and the view away therefrom. Thus, the rendering device may obtain images corresponding to the plurality of views positioned in the 3D space. For example, the rendering device may obtain an input image corresponding to an input view and augmented images corresponding to remaining views.

Thus, the rendering device may generate a 2D image at augmented viewpoints in advance using the Zero-1-to-3 model. Based on the LPIPS loss described above, the augmented image having a smallest deformation for the augmented views may be determined in consideration of cycle consistency.

FIG. 6 illustrates a scene restoration model according to an embodiment.

A rendering device may estimate scene information 670 based on input data 680 according to a scene restoration model 600. The scene restoration model 600 may be a machine learning model that is designed and trained to output the scene information 670 from the input data. The scene restoration model 600 may include a deformation estimation model 630 and an NSR estimation model 650. The deformation estimation model 630 may convert coordinates of a point in a 3D space into coordinates along a canonical frame 606 with reference to deformation code 682. The deformation estimation model 630 may be implemented as, for example, an MLP network.

The deformation code 682 may be code indicating a spatiotemporal deformation that appears in a predetermined frame, and may be obtained for each frame through training described below. The deformation code 682 may be a latent vector that uniquely maps to a predetermined frame among a plurality of frames that may be spatiotemporally divided. The canonical frame position information 605 may include coordinates along the canonical frame 606. The canonical frame 606 may be a kind of spatiotemporal reference frame, which may be a frame in which deformation occurring in a predetermined view is corrected with respect to an input view. The coordinates along the canonical frame 606 may be coordinates in which the deformation occurring in coordinates in the 3D space in a predetermined view is corrected. The NSR estimation model 650 may estimate color information 672 and volume density information 671 for the converted coordinates along the canonical frame 606.

The input data 680 may include point information 681, the deformation code 682, a ray direction 683, and latent appearance information 684. The input data 680 may also be referred to as a query input. The ray direction 683 may be a direction passing through points corresponding to a target pixel from a viewpoint from which a 2D scene 640 to be synthesized and/or restored is viewed. The 2D scene 640 may be a scene of a 3D space 660 captured at an FOV from a viewpoint 601, and a point 641 of the 2D scene 640 may correspond to a pixel of a 2D image (e.g., a scene image). In the example shown in FIG. 6, the point information 681 may include coordinates (x, y, z) indicating a target point X in the 3D space 660, and the ray direction 683 may include direction information (θ, ϕ) from the viewpoint 601 to the target point X. The coordinates (x, y, z) may be coordinates according to the Cartesian coordinate system based on a predetermined origin point, and the direction information (θ, ϕ) may be angles formed between the ray direction 683 and two predetermined reference axes (e.g., the positive direction of the z-axis and the positive direction of the x-axis).

According to an embodiment, the rendering device may generate the canonical frame position information 605 based on the point information 681 and the deformation code 682 according to the deformation estimation model 630. The canonical frame position information 605 may include coordinate information in which the point information 681 is corrected according to the deformation. The deformation may represent a spatiotemporal change between the canonical frame 606 (e.g., a frame corresponding to an input view) and a frame corresponding to a predetermined view. Although FIG. 6 shows only the point information 681 and the deformation code 682 as the input of the deformation estimation model 630, embodiments are not limited thereto. For example, in some embodiments the deformation estimation model 630 may additionally receive rotation information (e.g., rotation parameters and translational parameters) of the target view with respect to the input view.

In addition, the rendering device may generate the scene information 670 based on the canonical frame position information 605 and the ray direction 683 according to the NSR estimation model 650. The NSR estimation model 650 may include, for example, a volume density estimation network 651 and a color estimation network 652. The volume density estimation network 651 and the color estimation network 652 may each be implemented as an MLP network including a neural network.

The rendering device may generate an embedding vector (or a latent vector) and the volume density information 671 from the canonical frame position information 605 based on the volume density estimation network 651. As described above, the volume density information 671 may include a volume density value at a corresponding target point (e.g., X).

The rendering device may estimate the color information 672 based on the color estimation network 652 from additional inputs along with the embedding vector. The additional inputs may include, for example, the ray direction 683 and the latent appearance information 684. An example of the ray direction 683 is described above. As described above, the color information 672 may include a color value in a case where the target point is viewed in the ray direction 683. According to embodiments, when estimating the color information 672, the rendering device may additionally input the latent appearance information 684 (e.g., a latent appearance code) to the NSR estimation model 650 (e.g., the color estimation network 652). The latent appearance information 684 may be information indicating an environment (e.g., camera setting, a camera model, or lighting at a specific viewpoint) that may potentially affect the color of an individual point.

According to embodiments, X (or Xᵢ) may denote coordinates of a 3D point sampled according to the ray direction 683 in the 3D space 660 of an i-th frame (e.g., tᵢ). A frame may be a spatiotemporal frame. The direction information (θ, ϕ) may indicate the ray direction 683. The deformation code 682 may be denoted Wᵢ, and may be, for example, code indicating the spatiotemporal deformation that appears in the i-th frame. The latent appearance information 684 may be denoted ψᵢ is, and may include, for example, latent appearance code for color correction of a scene (e.g., a scene corresponding to the i-th frame or a scene captured by another camera). a volume density calculated for a corresponding input may be denoted σ, and c may denote an RGB color value calculated for a corresponding input.

According to embodiments, the deformation code 682 and the latent appearance code may be determined through training of the scene restoration model 600. For example, a training device (e.g., a rendering device) may calculate an objective function value based on an output of forward propagation of the deformation code 682 indicating the i-th frame (e.g., tᵢ), the target point, the ray direction, and the latent appearance code to the scene restoration model 600. The training device may output the temporary scene information 670 (e.g., the color information 672 and the volume density information 671) based on the forward propagation of the scene restoration model 600, and a temporary pixel value 691 corresponding to a 2D scene image 695 may be obtained from the temporary scene information 670 by performing volume rendering 690. An example of the volume rendering 690 is described below. The objective function (e.g., a rendering loss) may be determined, for example, based on a difference (e.g., an L2 loss) between a pixel value of a GT color image and the temporary pixel value 691 based on the forward propagation described above. However, the objective function value is not limited thereto, and may vary depending on the design.

The training device may update parameters (e.g., connection weights) of the scene restoration model 600 (e.g., the color estimation network 652, the volume density estimation network 651, and the deformation estimation model 630) based on the back propagation so that the objective function value changes in a certain direction (e.g., a decreasing direction). At this time, the training device may also update the deformation code 682 as well as the parameters of the neural network. When the training is completed, the deformation code 682 indicating each frame may be determined. The unique deformation codes 682 may be individually mapped to each of the frames. Similarly, the latent appearance information 684 (e.g., the latent appearance code) may be determined by the update through the training. The unique latent appearance codes may be individually mapped to each of environments. The rendering device may receive the deformation code 682 and, additionally, the latent appearance code, and may input these to the scene restoration model 600 during an inference operation of the scene information 670 using the scene restoration model 600.

According to an embodiment, the rendering device (e.g., the training device) may use images corresponding to a plurality of views as training data. For example, the rendering device may train the scene restoration model 600 (e.g., a 3D model) using the images corresponding to the plurality of views. The training data may include a predetermined augmented view (e.g., an augmented viewpoint and an augmented view direction) as a training input, and an augmented image corresponding to the augmented view as a training output.

The rendering device may generate a temporary image by providing the scene restoration model 600 with the deformation code 682 and coordinates for each of a plurality of points in a 3D space along a ray of each of a plurality of pixels in a 2D scene corresponding to a view to be restored. For example, based on a view given as the training input, the rendering device may determine a ray bundle corresponding to the view. As described above, a ray bundle may be a plurality of rays that are individually directed from the viewpoint to a plurality of pixels for forming a scene image. The rendering device may generate the scene information 670 for a plurality of points along each ray of the ray bundle. The rendering device may perform the volume rendering 690 on points along the ray corresponding to the pixel using the scene information 670 output by the scene restoration model 600. As a result of the volume rendering 690, the rendering device may determine the pixel value 691 of a corresponding pixel. The rendering device may generate the scene image 695 by determining the pixel value 691 for all pixels in the scene. The scene image 695 generated by the training may be referred to as a temporary image.

The rendering device may update the deformation code 682 and the parameters of the scene restoration model 600 based on a loss between the generated temporary image and a training image (e.g., a GT image) corresponding to the 2D scene. For example, the temporary image may be the scene image 695 generated for any one of the plurality of views. The training image (e.g., the GT image as a training output) may be an image (e.g., an input image or an augmented image) corresponding to the view. The rendering device may calculate a loss between the restored scene image 695 and the GT image (e.g., the input image or the augmented image of FIG. 5) described above. The rendering device may update the deformation code 682 and the parameter of the scene restoration model 600 such that the calculated loss converges.

The rendering device may use a variety of loss calculation methods depending on the view. For example, the rendering device may use score distillation sampling (SDS) loss and L2 loss (or L1 loss). When the GT image is an input image, the rendering device may calculate the L2 loss between the input image and the temporary image restored based on the input view. When the GT image is an augmented image, the rendering device may calculate the SDS loss between the augmented image and the temporary image restored based on the augmented view.

The rendering device may map the deformation code 682 converged to a frame identifier indicating a training image, based on a convergence obtained by updating of the deformation code 682 and the parameter of the scene restoration model 600. The frame identifier may indicate a spatiotemporal frame. For example, when the training image is a front image of an object, the deformation code 682 converged in the training using the front image may be mapped to a frame identifier indicating a frame of a front view. In another example, when the training image is a side image of an object, the deformation code 682 converged in the training using the side image may be mapped to a frame identifier indicating a frame of a side view. As described above, a network including the deformation estimation model 630 and the NSR estimation model 650 may be referred to as a deformable NeRF network. The deformable NeRF network may include, for example, a HyperNeRF model. The deformation estimation model 630 in the deformable NeRF network may be trained according to the mapping between a frame (e.g., the canonical frame 606) corresponding to the input image and frames corresponding to the augmented images. A shape of the object shown in the canonical frame 606 may be a canonical shape. The mapping between the frames described above may be mapping between the canonical shape and the remaining shapes. By setting the canonical shape to a 3D shape to be generated, 3D consistency may be further improved.

The rendering device may generate the scene information 670 including the color information 672 and the volume density information 671 based on the trained scene restoration model 600. The rendering device may determine the pixel value 691 by performing the volume rendering 690 on the scene information 670. The volume rendering 690 may be an operation of accumulating values calculated using color values and volume density values as the scene information 670 estimated for points sampled along a ray corresponding to a pixel to determine the pixel value 691 corresponding to the pixel. An equation used for the volume rendering 690 (e.g., a volume rendering equation) may be expressed according to, for example, Equation 2 below. The rendering device may use the volume rendering equation to calculate the color value for the pixel position.

$$C ( r ) = {\sum }_{k} {w}_{k} {c}_{k} , \\ where {w}_{k} = {T}_{k} ( 1 - exp ( σ ( {r}_{k} ) δ ( {r}_{k} ) ) \\ {c}_{k} = c ( {r}_{k} ) \qquad ( Equation 2 )$$

In Equation 2 above, the points on the ray according to an embodiment may be sampled at predetermined intervals by a predetermined number. For example, K points on the ray may be sampled at regular intervals to obtain a total of K 3D positions, and r₁, . . . , r_{K}. r₁, . . . , r_{K} may denote points each sampled at a ray r. Here, K may be an integer greater than or equal to 1, and k may be an integer between 1 and K, inclusive. The transmittance to a k-th point on the ray may be denoted Tₖ. The transmittance Tₖ may be determined by volume densities σ(rₖ) and δ(rₖ) at the position as shown in Equation 2. According to embodiments, the volume density δ(rₖ) may correspond to an interval between the k-th point and a point adjacent thereto on the ray, and cₖ may denote a color value of the k-th point. Thus, according to Equation 2, a pixel color value may be a weighted sum between the transmitted Tₖ and the color value cₖ calculated for the points on the ray. The rendering device may restore the scene image 695 by repeatedly determining (e.g., by performing the volume rendering 690) the pixel value 691 for each pixel of the scene image 695 corresponding to a view to be restored. Accordingly, the rendering device may perform the volume rendering 690 described above on all pixel positions in a scene corresponding to a target view to obtain the 2D scene image 695 (e.g., an RGB image) for the target view.

Although the example of FIG. 6 is described as an example in which the scene restoration model 600 is a NeRF-based model, embodiments are not limited thereto. For example, in some embodiments the scene restoration model 600 may also be a model based on mesh representation. In the mesh representation, a difference between an actual image and an image rendered through a differentiable renderer (e.g., a soft rasterizer) may be compared, and the training may be performed about how to deform the 3D mesh to reduce this difference.

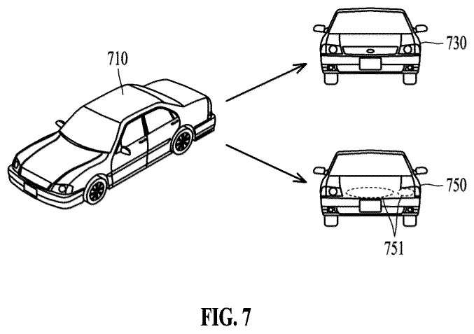

FIG. 7 illustrates generation of a scene image representing an object that has changed over time using a scene restoration model according to an embodiment.

A rendering device according to an embodiment may generate a 2D scene image 730 of a target view based on an input image 710 of an input view using the scene restoration model (e.g., the scene restoration model 600) and volume rendering (e.g., the volume rendering 690) described above with reference to FIG. 6. As a comparative example, an image 750 of the target view may be generated based on the input image 710 using only a diffusion model. As shown in FIG. 7, a detail of the object is preserved in the 2D scene image 730 generated according to embodiments, however, a detail 751 of the object such as a headlight of a vehicle may be lost in the image 750 according to the comparative example. The rendering device may restore a scene image having photorealistic shapes and colors with reduced noise using the scene restoration model described above.

FIG. 8 is a block diagram illustrating an example of a configuration of a rendering device according to an embodiment.

Referring to FIG. 8, a rendering device 800 may include a processor 810 and a memory 820. The memory 820 may be connected to the processor 810, and may store instructions executable by the processor 810, data to be computed by the processor 810, or data processed by the processor 810. The memory 820 may include, for example, a non-transitory computer-readable storage medium, for example, a high-speed random access memory (RAM) and/or a non-volatile computer-readable storage medium (for example, at least one disk storage device, a flash memory device, or other non-volatile solid state memory devices). The memory 820 may store a view change model and a scene restoration model.

The processor 810 may execute instructions to perform the operations described above with reference to FIGS. 1 to 6. For example, the processor 810 may obtain an input image of an object. For example, the input image may be obtained by capturing an image of the object. The processor 810 may determine a plurality of augmented viewpoints surrounding the object in a 3D space including the object, based on an input viewpoint corresponding to the input image. The processor 810 may generate a plurality of augmented images at the plurality of augmented viewpoints, wherein each augmented image from among the plurality of augmented images corresponds to a view of the object from a corresponding augmented viewpoint from among the plurality of augmented viewpoints, wherein each augmented image may be generated based on an image at another viewpoint (e.g., a different viewpoint) using a view change model. The processor 810 may generate a scene restoration model based on the input image at the input viewpoint and the plurality of augmented images at the plurality of augmented viewpoints, and may restore a scene image of a target view using the scene restoration model. In addition, the description provided with reference to FIGS. 1 to 6 may apply to the rendering device 800.

FIG. 9 is a block diagram illustrating an example of a configuration of an electronic device according to an embodiment.

Referring to FIG. 9, an electronic device 900 may include a processor 910, a memory 920, a camera 930, a storage device 940, an input device 950, an output device 960, and a network interface 970, which may communicate with each other through a communication bus 980. For example, the electronic device 900 may be implemented as at least a part of a mobile device such as a mobile phone, a smart phone, a personal digital assistant (PDA), a netbook, a tablet computer or a laptop computer, a wearable device such as a smart watch, a smart band or smart glasses, a computing device such as a desktop or a server, a home appliance such as a television, a smart television or a refrigerator, a security device such as a door lock, or a vehicle such as an autonomous vehicle or a smart vehicle. The electronic device 900 may include, structurally and/or functionally, the rendering device 800 of FIG. 8.

The processor 910 may execute instructions and functions in the electronic device 900. For example, the processor 910 may process instructions stored in the memory 920 or the storage device 940. The processor 910 may perform the operations described with reference to FIGS. 1 to 8. The memory 920 may include a non-transitory computer-readable storage medium or a non-transitory computer-readable storage device. The memory 920 may store instructions that are to be executed by the processor 910, and also store information associated with software and/or applications when the software and/or applications are being executed by the electronic device 900.

The camera 930 may capture a photo and/or a video. For example, the camera 930 may capture an input image of an input view. The storage device 940 may include a non-transitory computer-readable storage medium or a non-transitory computer-readable storage device. The storage device 940 may store a greater amount of information than the memory 920 and store the information for a long period of time. For example, the storage device 940 may include magnetic hard disks, optical disks, flash memories, floppy disks, or other forms of non-volatile memories known in the art.

The input device 950 may receive an input from a user through a traditional input scheme using a keyboard and a mouse, and through a new input scheme such as a touch input, a voice input and an image input. For example, the input device 950 may detect an input from a keyboard, a mouse, a touchscreen, a microphone or a user, and may include any other device configured to transfer the detected input to the electronic device 900. The output device 960 may provide a user with an output of the electronic device 900 through a visual channel, an auditory channel, or a tactile channel. The output device 960 may include, for example, a display, a touchscreen, a speaker, a vibration generator, or any other device configured to provide a user with the output. The network interface 970 may communicate with an external device via a wired or wireless network.

The embodiments described herein may be implemented using a hardware component, a software component, and/or a combination thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For simplicity, the processing device is described as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs, digital versatile discs (DVDs), and/or Blu-ray discs; magneto-optical media such as optical discs; and hardware devices that are specially configured to store and perform program instructions, such as read-only memory (ROM), random access memory (RAM), flash memory (e.g., universal serial bus (USB) flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

Although some embodiments are described above with reference to the limited drawings, a person skilled in the art may apply various technical modifications and variations based thereon without departing from the scope of the disclosure. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A scene restoration method performed by at least one processor, the scene restoration method comprising:
obtaining an input image of an object;
based on an input viewpoint corresponding to the input image, determining a plurality of augmented viewpoints surrounding the object in a three-dimensional (3D) space comprising the object;
generating a plurality of augmented images at the plurality of augmented viewpoints, wherein each augmented image from among the plurality of augmented images corresponds to a view of the object from a corresponding augmented viewpoint from among the plurality of augmented viewpoints, and wherein each augmented image is generated based on an image at a different viewpoint using a view change model;
generating a scene restoration model based on the input image at the input viewpoint and the plurality of augmented images at the plurality of augmented viewpoints; and
restoring a scene image of a target view of the object using the scene restoration model.

2. The scene restoration method of claim 1, wherein the determining of the plurality of augmented viewpoints comprises determining positions on a surface of a virtual solid figure surrounding the object in the 3D space as the plurality of augmented viewpoints.

3. The scene restoration method of claim 1, wherein the generating of the each augmented image based on the image at the different viewpoint using the view change model comprises:
determining a plurality of reference viewpoints around the each augmented viewpoint;
generating a plurality of candidate images at the each augmented viewpoint based on a plurality of reference images at the plurality of reference viewpoints using the view change model; and
selecting an augmented image at the each augmented viewpoint from among the plurality of candidate images.

4. The scene restoration method of claim 3, wherein the selecting of the augmented image comprises:
obtaining a retransformed image by transforming each candidate image from among the plurality of candidate images to a corresponding reference viewpoint using the view change model; and
selecting the augmented image based on a comparison between the retransformed image and a corresponding reference image.

5. The scene restoration method of claim 4, wherein the selecting of the augmented image comprises:
calculating a learned perceptual image patch similarity (LPIPS) loss between the retransformed image and the corresponding reference image; and
selecting a candidate image having a smallest LPIPS loss from among the plurality of candidate images as the augmented image.

6. The scene restoration method of claim 1, wherein the generating of the augmented image based on the image at the different viewpoint using the view change model comprises generating an augmented image at each augmented viewpoint sequentially in an order of increasing distance from the input viewpoint.

7. The scene restoration method of claim 1, wherein the view change model comprises a diffusion model, and
wherein the generating of the plurality of augmented images comprises:
providing parameters based on a rotation parameter and a translation parameter for transformation of a reference viewpoint into an augmented viewpoint to the diffusion model together with a reference image at the reference viewpoint to generate a candidate image at the augmented viewpoint; and
providing a parameter for transformation of the augmented viewpoint into the reference viewpoint to the diffusion model together with the candidate image at the augmented viewpoint to generate a retransformed image.

8. The scene restoration method of claim 1, wherein the restoring of the scene image comprises:
generating scene information comprising color information and volume density information based on the scene restoration model; and
restoring the scene image by repeatedly determining a pixel value for each pixel from among a plurality of pixels in a view to be restored by performing volume rendering on the scene information.

9. The scene restoration method of claim 1, wherein the scene restoration model comprises:
a deformation estimation model configured to convert coordinates of a point in the 3D space into coordinates corresponding to a canonical frame with reference to deformation code; and
a neural scene representation (NSR) estimation model configured to estimate color information and volume density information based on the converted coordinates according to the canonical frame.

10. The scene restoration method of claim 1, wherein the generating of the scene restoration model comprises:
generating a temporary image by providing, to the scene restoration model, a deformation code and coordinates for each point from among a plurality of points in the 3D space corresponding to a ray for each pixel in a two-dimensional (2D) scene corresponding to a view to be restored;
updating parameters of the scene restoration model and the deformation code based on a loss between the generated temporary image and a training image corresponding to the 2D scene; and
based on the updating of the parameters of the scene restoration model and the deformation code converging, mapping the converged deformation code to a frame identifier indicating the training image.

11. A rendering device comprising:
a memory configured to store a view change model and a scene restoration model; and
at least one processor configured to:
obtain an input image of an object,
based on an input viewpoint corresponding to the input image, determine a plurality of augmented viewpoints surrounding the object in a three-dimensional (3D) space comprising the object,
generate a plurality of augmented images at the plurality of augmented viewpoints, wherein each augmented image from among the plurality of augmented images corresponds to a view of the object from a corresponding augmented viewpoint from among the plurality of augmented viewpoints, and wherein each augmented image is generated based on an image at a different viewpoint using the view change model,
generate the scene restoration model based on the input image at the input viewpoint and the plurality of augmented images at the plurality of augmented viewpoints, and
restore a scene image corresponding to a target view of the object using the scene restoration model.

12. The rendering device of claim 11, wherein the at least one processor is further configured to determine positions on a surface of a virtual solid figure surrounding the object in the 3D space as the plurality of augmented viewpoints.

13. The rendering device of claim 11, wherein the at least one processor is configured to:
determine a plurality of reference viewpoints around the each augmented viewpoint;
generate a plurality of candidate images at the each augmented viewpoint based on a plurality of reference images at the plurality of determined reference viewpoints using the view change model; and
select an augmented image at the each augmented viewpoint from among the plurality of candidate images.

14. The rendering device of claim 13, wherein the at least one processor is further configured to:
obtain a retransformed image by transforming each candidate image from among the plurality of candidate images to a corresponding reference viewpoint using the view change model; and
select the augmented image based on a comparison between the retransformed image and a corresponding reference image.

15. The rendering device of claim 14, wherein the at least one processor is further configured to:
calculate a learned perceptual image patch similarity (LPIPS) loss individually between the retransformed image and the corresponding reference image; and
select a candidate image having a smallest LPIPS loss from among the plurality of candidate images as the augmented image.

16. The rendering device of claim 11, wherein the at least one processor is further configured to generate an augmented image at each augmented viewpoint sequentially in an order of increasing distance from the input viewpoint.

17. The rendering device of claim 11, wherein the view change model comprises a diffusion model, and
wherein the at least one processor is further configured to:
provide parameters based on a rotation parameter and a translation parameter for transformation of a reference viewpoint into an augmented viewpoint to the diffusion model together with a reference image at the reference viewpoint to generate a candidate image at the augmented viewpoint; and
provide a parameter for transformation of the augmented viewpoint into the reference viewpoint to the diffusion model together with the candidate image at the augmented viewpoint to generate a retransformed image.

18. The rendering device of claim 11, wherein the at least one processor is further configured to:
generate scene information comprising color information and volume density information based on the scene restoration model; and
restore the scene image by repeatedly determining the pixel value for each pixel from among a plurality of pixels in a view to be restored by performing volume rendering on the scene information.

19. The rendering device of claim 11, wherein the scene restoration model comprises:
a deformation estimation model configured to convert coordinates of a point in the 3D space into coordinates corresponding to a canonical frame with reference to deformation code; and
a neural scene representation (NSR) estimation model configured to estimate color information and volume density information based on the converted coordinates according to the canonical frame.

20. The rendering device of claim 11, wherein the at least one processor is further configured to:
generate a temporary image by providing, to the scene restoration model, a deformation code and coordinates for each point from among a plurality of points in the 3D space corresponding to a ray for each pixel in a two-dimensional (2D) scene corresponding to a view to be restored;
update parameters of the scene restoration model and the deformation code based on a loss between the generated temporary image and a training image corresponding to the 2D scene; and
based on the updating of the parameters of the scene restoration model and the deformation code converging, map the converged deformation code to a frame identifier indicating the training image.
